(19) United States
(12) Patent Application Publication
(10) Pub. No.: US 2020/0142494 A1
(43) Pub. Date: May 7, 2020

(54) DYNAMIC DEVICE INTERACTION RECONFIGURATION USING BIOMETRIC PARAMETERS

(71) Applicant: International Business Machines Corporation, Armonk, NY (US)

(72) Inventors: Craig M. Trim, Ventura, CA (US); Martin G. Keen, Cary, NC (US); Rebecca D. Young, Toronto (CA); Sarbajit K. Rakshit, Kolkata (IN)

(73) Assignee: International Business Machines Corporation, Armonk, NY (US)

(21) Appl. No.: 16/178,181

(22) Filed: Nov. 1, 2018

(51) Int. Cl. G06F 3/01; G06F 21/32; G06F 9/445

(52) U.S. Cl. CPC G06F 3/017; G06F 9/44505; G06F 21/32

(57) ABSTRACT

A method, system, and computer program product for dynamic device interaction reconfiguration includes detecting an anomaly in a first input gesture. An embodiment includes determining whether the anomalous gesture resolves to a unique event. An embodiment includes reconfiguring, responsive to the anomalous gesture failing to resolve to the unique event, the anomalous gesture to an output gesture by (i) accepting a second input gesture instead of the first input gesture, and (ii) replacing the second input gesture with a standard first gesture as output to a target application. An embodiment includes resolving the output gesture to the unique event. An embodiment includes causing, responsive to the output gesture, the unique event to occur at the target application.

### TECHNICAL FIELD

The present invention relates generally to a method, system, and computer program product for a device interaction reconfiguration. More particularly, the present invention relates to a method, system, and computer program product for dynamic device interaction reconfiguration using biometric parameters.

### BACKGROUND

Wireless communications (mobile communications) enable users to perform a variety of tasks using their mobile devices. An ever increasing number of applications is available for the wireless data processing systems, wireless data communication devices, or wireless computing platforms (collectively and interchangeably, “mobile device” or “mobile devices”). For example, many mobile devices not only allow the users to make voice calls, but also exchange emails and messages, access remote data processing systems, and perform web-based interactions and transactions.

Wearable devices are a category of mobile devices. A wearable device is essentially a mobile device, but has a form-factor that is suitable for wearing the device on a user's person. A user can wear such a device as an article of clothing, clothing or fashion accessory, jewelry, a prosthetic or aiding apparatus, an item in an ensemble, an article or gadget for convenience, and the like. Some examples of presently available wearable devices include, but are not limited to, smart watches, interactive eyewear, devices embedded in shoes, controllers wearable as rings, and pedometers.

Some wearable devices are independent wearable devices in that they can operate as stand-alone mobile devices. Such a wearable device either includes some or all the capabilities of a mobile device described above or does not need or use the capabilities of a mobile device described above.

Other wearable devices are dependent wearable devices in that they operate in conjunction with a mobile device. Such a wearable device performs certain functions while in communication with a mobile device described above.

Sensors track biometric parameters of a user. A sensor can be a component of a mobile device, wearable device, or office equipment, such as a chair or desk. Some examples of presently available sensors include, but are not limited to, cameras, accelerometers, heartrate monitors, strain gauges, and pressure sensors. A biometric parameter can be a physical condition of a user. Some examples of biometric parameters include, but are not limited to, muscle strain, muscle fatigue, heartrate, posture, and broken bones.

### SUMMARY

The illustrative embodiments provide a method, system, and computer program product for dynamic device interaction reconfiguration. An embodiment includes a method for dynamic device interaction reconfiguration including detecting an anomaly in a first input gesture.

The embodiment further includes determining whether the anomalous gesture resolves to a unique event. The embodiment further includes reconfiguring, responsive to the anomalous gesture failing to resolve to the unique event, the anomalous gesture to an output gesture by (i) accepting a second input gesture instead of the first input gesture, and (ii) replacing the second input gesture with a standard first gesture as output to a target application.

The embodiment further includes resolving the output gesture to the unique event. The embodiment further includes causing, responsive to the output gesture, the unique event to occur at the target application.

An embodiment further includes identifying, responsive to the anomalous gesture failing to resolve to the unique event, a condition in a performance of the first input gesture. In an embodiment, the condition corresponds to a physical condition of a user.

In an embodiment, the identifying is performed at an application executing using a processor and a memory in a wearable device. In an embodiment, the anomaly corresponds to the first input gesture failing to meet a threshold metric.

In an embodiment, a threshold metric is a threshold gesture data. An embodiment includes accepting the second input gesture instead of the first input gesture further comprising: replacing gesture data corresponding to the anomalous gesture with gesture data corresponding to the second input gesture.

An embodiment includes accepting the second input gesture instead of the first input gesture further comprising: removing the anomaly from gesture data corresponding to the first input gesture.

An embodiment includes notifying the target application of the replacement. In an embodiment, the detecting is performed at an application executing using a processor and a memory in a wearable device.

An embodiment includes overwriting an association of the stored gesture with the first event. In an embodiment, the first input gesture comprises a series of motions.

In an embodiment, the method is embodied in a computer program product comprising one or more computer-readable storage devices and computer-readable program instructions which are stored on the one or more computer-readable tangible storage devices and executed by one or more processors.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for dynamic device interaction reconfiguration in accordance with an illustrative embodiment;

FIG. 4 depicts a block diagram of an example manner of accepting a second input gesture instead of the first input gesture in accordance with an illustrated embodiment;

FIG. 5 depicts a block diagram of an example manner of resolving an output gesture to a unique event in accordance with an illustrated embodiment; and

FIG. 6 depicts a flowchart of an example process for dynamic device interaction reconfiguration in accordance with an illustrative embodiment.

### DETAILED DESCRIPTION

In some cases, an operation described in an embodiment is implementable in a mobile device, a wearable device, or both. Additionally, in some cases, an operation described in an embodiment as an operation in a mobile device can be implemented as an operation in a wearable device, and vice-versa.

The illustrative embodiments recognize that mobile devices track or detect a user's gestures to cause an operation of those mobile devices. Generally, the illustrative embodiments recognize that a user's hand or arm (hand) is a very versatile limb and performs a range of gestures that few other limbs or appendages, if any, can perform. A part of a hand can be, but is not limited to, a wrist, a finger, a joint in the hand, a muscle in the hand, a nerve in the hand, and the like, where physical gestures or movements (collectively, “gestures”) can be detected.

Within the scope of the illustrative embodiments, a gesture is any gesture that is detectable at a mobile device. For example, a gesture that is detectable by a wearable device worn on a user's hand or a part thereof is contemplated within the scope of the illustrative embodiments. Lifting of the arm, twisting of the wrist, tapping of a finger, pulsing of a nerve, and flexing of a muscle are some non-limiting examples of gestures contemplated within the scope of the illustrative embodiments. A gesture according to some of the illustrative embodiments includes a series of motions. For example, a single gesture can include a swipe motion and a tap motion.

Wearable devices, such as ring-type wearable television controllers, track gestures to cause an operation of those devices. For example, a user wearing a ring controller performs a single ‘push’ gesture in the air, with the finger on which the ring controller is worn, for the ring controller to detect that gesture as an input to perform a ‘power On’ operation. Similarly, a single ‘swipe left’ gesture in the air, with the finger on which the ring controller is worn, causes the ring controller to detect that gesture as an input to perform a ‘change channel’ operation.

Mobile devices, such as touch-screen mobile phones, also track gestures to cause an operation of those devices. For example, a horizontal ‘swipe left’ gesture on a touch-screen device causes the touch-screen device to detect that gesture as an input to perform an ‘unlock’ operation. Additionally, components of mobile devices track gestures to cause an operation of those devices. For example, a press gesture on a side of the device causes the device to detect that gesture as an input to perform a ‘volume up’ operation. Similarly, a press gesture on a face of the device causes the device to detect that gesture as an input to perform a ‘return to home screen’ operation.

Sensors, such as cameras, also track gestures to cause an operation of mobile devices. For example, a camera tracks eye movement of a user and the mobile device detects that gesture as an input to perform a ‘scrolling’ operation. Additionally, a facial movement, such as, a ‘blink’ gesture by a user causes the mobile device to detect that gesture as an input to perform a ‘select’ operation.

A pattern of one or more gestures (gesture pattern) according to the illustrative embodiments comprises a series of gestures. A gesture pattern can be, but need not necessarily be, a discrete gesture in a discrete time. In other words, a gesture pattern can be one or more gestures spanning a finite length of time in some order. Furthermore, a gesture pattern can comprise repetitive performance of one gesture, performance of different gestures, or a combination thereof.

Additionally, a gesture pattern can be, but need not necessarily be continuous. In other words, a gesture pattern according to the illustrative embodiments can include zero or more pauses or periods of no gestures, i.e., periods where no gesture is detected.

The illustrative embodiments recognize that physical limitations often prevent a user from performing one or more gestures. A physical limitation is any physical condition of a user that prevents the user from performing one or more gestures. Physical limitations can be temporary or permanent. For example, a user's broken thumb prevents the user from performing a horizontal ‘swipe left’ gesture on a touch-screen device. Additionally, a user's broken wrist or arm prevents the user from performing any gesture with the user's hand.

The illustrative embodiments recognize that certain gestures are easier to perform than other gestures for a user with particular physical limitations. For example, a vertical ‘swipe up’ gesture performed with an index finger may be easier to perform than a horizontal ‘swipe left’ gesture for a user with a broken thumb. The illustrative embodiments additionally recognize that gestures using a component of the device are easier for a user than touch-screen gestures for user's with particular physical issues. For example, pressing a button on the device can be easier to perform than a ‘swipe’ gesture for a user with a broken wrist.

Furthermore, the illustrative embodiments recognize that physical limitations arise from prolonged activity with a device. For example, muscle fatigue can arise from prolonged use of a device. Additionally, muscle strain can arise from multiple repetitive gestures.

The illustrative embodiments used to describe the invention generally address and solve the above-described problems and other problems related to dynamic device interaction reconfiguration. The illustrative embodiments provide a method, system, and computer program product for dynamic device interaction reconfiguration using biometric parameters.

An embodiment can be implemented in hardware or firmware in a mobile device, or in a combination of a wearable device and a mobile device. An embodiment can also be implemented as software instructions.

An embodiment detects, at a user's body or a part thereof, a gesture pattern comprising one or more gestures over a period. The embodiment associates the gesture pattern with an event or activity (collectively, event). The event can be an activity that the user is performing using the gesture pattern, an activity that the user wants to associate with the gesture pattern, an activity that an embodiment associates with the gesture pattern by default or pre-configuration, an activity unrelated to the gesture pattern but associated with the gesture pattern according to a rule or preference.

For example, the user may have a broken thumb. An embodiment detects one or more gestures associated with an input of a device. The embodiment detects an anomaly in a first input gesture. An embodiment detects the first input gesture fails to meet a threshold metric. A threshold metric includes a threshold gesture data. For example, an embodiment can detect the first input gesture fails to meet a threshold metric of a swipe gesture occurring over a distance of eighty percent of a touchscreen of a device. Similarly, an embodiment can detect the first input gesture fails to meet a threshold metric of time, such as three seconds, to complete the first input gesture.

An embodiment detects the first input gesture deviates from past performances of a gesture. The embodiment compares the first input gesture to past performances of the gesture stored in a repository. For example, an embodiment can detect a gesture pattern contains the same series of gestures as a previous gesture pattern, however, the user takes longer to perform the gesture pattern. Similarly, an embodiment detects an accuracy of the gesture differs from past performances of the same gesture. For example, an embodiment can detect tapping a touch screen icon off-center from previous gestures.

The above example is described to clarify certain operations of various embodiments, and not to imply a limitation. The illustrative embodiments are described with respect to certain gestures, gesture patterns, body parts, motions, movements, motion patterns, activities, actions, biometric parameters, biometric measurements, repositories, physical limitations, events, operations, use-cases, collaborative data, collaborative sources, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

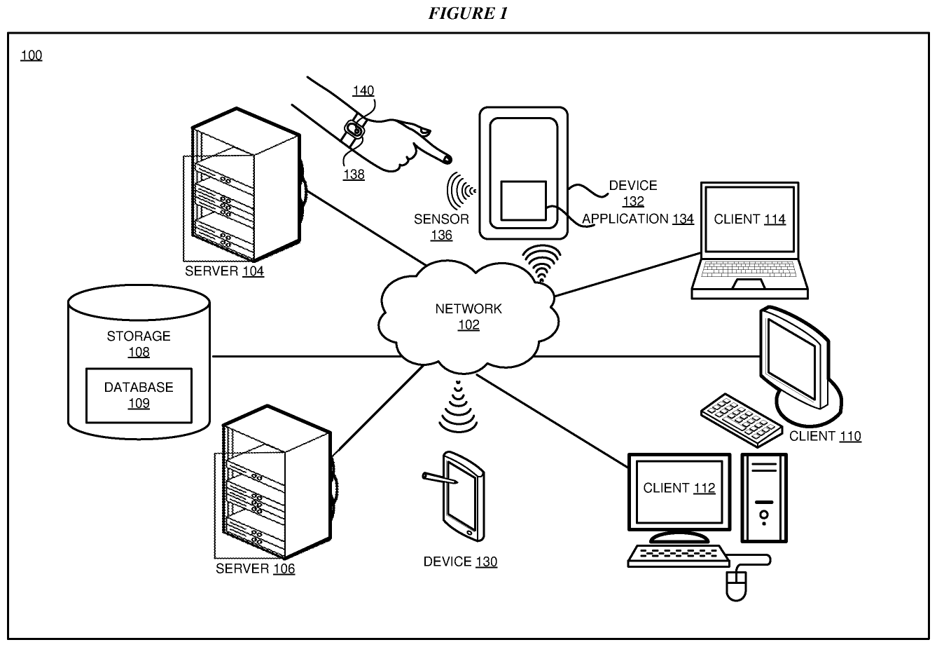

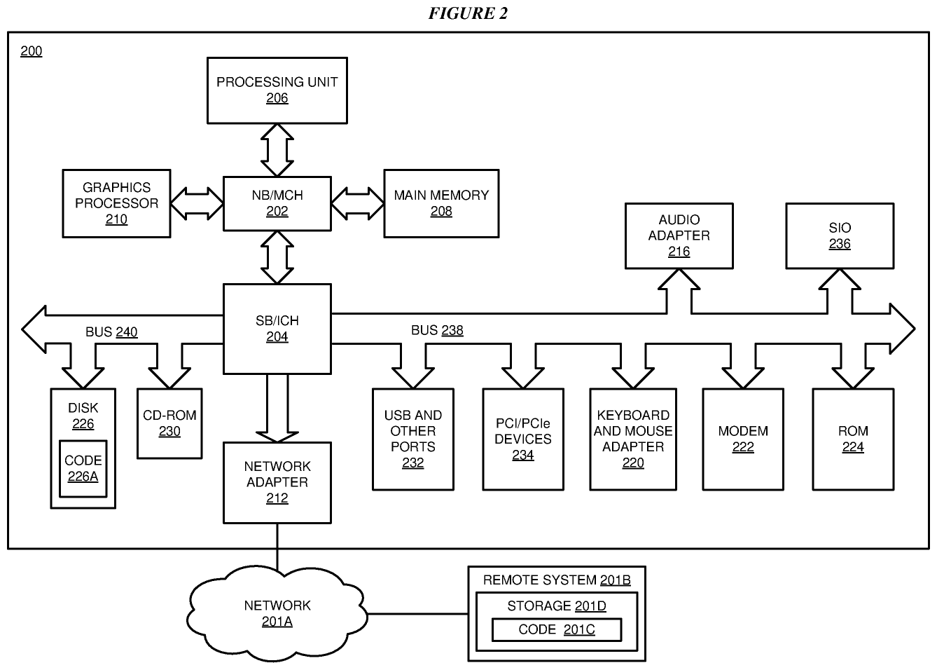

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Storage unit 108 includes a database 109. In an embodiment, database 109 contains gestures, conditions, and biometric parameters. For example, database 109 can contain past anomalous gestures detected at a device in the network. In an embodiment, database 109 contains associations between detected anomalous gestures, conditions, and biometric parameters. In an embodiment, database 109 stores gestures, conditions, biometric parameters, and associations from past users. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Devices 130, 132 are examples of a device described herein. For example, device 132 can take the form of a smartphone, a tablet computer, a laptop computer, client 110 in a stationary or a portable form, a wearable computing device, or any other suitable device that can be configured for requesting entity reviews and analysis reports. Wearable device 138 can be either an independent wearable device or a dependent wearable device operating in conjunction with device 132, as described herein, such as over a wired or wireless data communication network. Application 134 implements an embodiment described herein to operate with wearable device 138, to perform an operation described herein, or both. Application 134 can be configured to use a sensor or other component (not shown) of device 132 to perform an operation described herein. Similarly, application 140 implements an embodiment described herein to perform an operation described herein, to operate with device 132, or both. Application 140 can be configured to use sensor 136 or other component (not shown) of wearable device 138 to perform an operation described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 or data processing system 138 in FIG. 1 in which computer usable program code or instructions implementing the processes of the illustrative embodiments may be located. Data processing system 200 is described as a computer only as an example, without being limited thereto. Implementations in the form of other devices, such as device 132 or device 138 in FIG. 1, may modify data processing system 200, modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system. An object oriented programming system may run in conjunction with the operating system and provide calls to the operating system from programs or applications executing on data processing system 200.

Instructions for the operating system, the object-oriented programming system, and applications or programs, such as application 134 or application 140 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

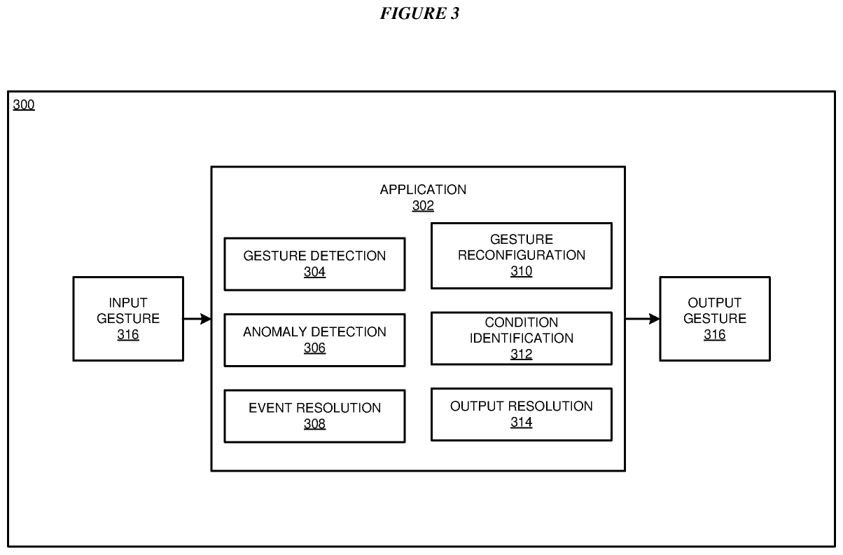

With reference to FIG. 3, this figure depicts a block diagram of an example configuration 300 for dynamic device interaction reconfiguration in accordance with an illustrative embodiment. The example configuration includes an application 302. In a particular embodiment, application 302 is an example of application 134, application 140, or some combination thereof, in FIG. 1.

Application 302 includes a gesture detection component 304, an anomaly detection component 306, an event resolution component 308, a gesture reconfiguration component 310, a condition identification component 312, and an output resolution component 314.

Gesture detection component 304 detects a gesture as input to the device. For example, component 304 can detect a swipe motion on a touchscreen of the device. Anomaly detection component 306 detects an anomaly in the first input gesture. For example, component 306 can determine the first input gesture fails to meet a threshold metric. Component 306 compares the first input gesture to a threshold metric. For example, component 306 can compare a distance of a swipe gesture to a threshold distance, such as a percentage or a distance on a touch screen. In an embodiment, component 306 compares a detected input gesture to past performances of the gesture stored in the gesture repository. For example, component 306 can compare an accuracy, a time, a contact pressure and other gesture measurements between the first input gesture and the stored gesture repository.

Event resolution component 308 determines whether anomalous gestures resolve to a unique event. For example, component 308 may determine tapping a touchscreen fails to resolve to opening an application with a nearby icon on the touchscreen because the tapping gesture failed to meet a threshold accuracy metric. Similarly, component 308 may determine a swiping motion fails to unlock the device because the swipe fails to meet a threshold distance metric.

Gesture reconfiguration component 310 reconfigures the first input gesture to an output gesture. Component 310 accepts a second input gesture instead of the first input gesture. For example, component 310 can accept an anomalous first input gesture instead of the first input gesture. In an embodiment, gesture reconfiguration component 310 corrects anomalies in the input gesture. Component 310 replaces gesture data of the anomalous input gesture. For example, component 310 can replace pressure data measured at the touchscreen during the first input gesture with pressure data satisfying a threshold pressure metric.

In an embodiment, component 310 accepts the second input gesture as a replacement for the first input gesture. For example, component 310 can accept a button press input gesture in place of a swipe gesture. Component 310 replaces gesture data from the replacement second input gesture with gesture data from the first input gesture. In some embodiments, the reconfiguration of is permanent. In other embodiments, the reconfiguration is temporary. In some embodiments, component 310 associates the second input gesture with a unique event. For example, component 310 can overwrite an association of the first input gesture with the unique event by replacing the association with a new association of the second input gesture with the unique event.

Gesture reconfiguration component 310 replaces the second input gesture with a standard input gesture as output to a target application. Standard input gesture causes the unique event to occur at the target application. For example, component 310 can replace gesture data for a replacement button press gesture with gesture data for a swipe gesture. Component 310 passes the swipe gesture data to the target application, causing the unique event associated with the swipe gesture to occur.

Condition identification component 312 identifies a condition in a performance of the first input gesture. In an embodiment, component 312 identifies a condition based on the detected anomaly. For example, component 312 can identify muscle fatigue based on input gesture pressure data failing to satisfy a threshold metric. In another embodiment, component 312 receives sensor data for use in identifying a condition in a performance of the first input gesture. For example, component 312 may use cameras to detect the user is wearing a cast on their hand. As a result, the user may have trouble holding the device in the correct position to perform a gesture or have a limited range of movement to perform the gesture. In some embodiments, component 312 identifies multiple conditions in a performance of the first input gesture. In an embodiment, component 312 identifies a condition in a performance of the first input gesture based on a stored database of detected anomalies. For example, component 312 can detect an anomalous swipe gesture corresponds to a broken thumb because previous swipe gestures featured the same anomaly.

In an embodiment, component 312 identifies a physical condition of a user. For example, component 312 can identify a physical limitation, such as a muscular issue, of a user. In an embodiment, component 312 receives biometric parameters associated with a user. For example, component 312 can receive a set of biometric parameter from a wearable device, such as wearable device 138 in FIG. 1. In an embodiment, component 312 analyzes the set of biometric parameters to identify a physical condition of the user. For example, component 312 can analyze a posture of the user and identify the user is compensating for an injury, such as a back injury. In an embodiment, component 312 analyzes a set of biometric parameters and predicts a physical condition of a user using the biometric parameters. For example, component 312 can analyze a slouching posture of a user and identify a potential sore back. As another example, component 312 can analyze a period of activation of a muscle group and identify a potential muscle strain or muscle fatigue. In an embodiment, component 312 analyzes a set of biometric parameters using a historical database, such as database 109 in FIG. 1, to identify a condition of the user associated with the set of biometric parameters. In an embodiment, component 310 accepts a second input gesture instead of the first input gesture in response to a predicted physical condition by component 312. For example, component 310 can accept a swipe up gesture in place of a swipe left gesture if component 312 determines the user has a broken hand.

Output resolution component 314 controls and manages associating output gesture with actions to be performed by the device. For example, component 314 associates a ‘swipe left’ gesture with unlocking the device. Output resolution component 314 reconfigures associations between output gestures and actions performed by the device based upon detected anomalies. Component 314 resolves an output gesture from component 310 with a unique event configured to occur at application 316. For example, component 314 may resolve a swipe output gesture to opening a file. In an embodiment, component 314 notifies application 316 of the reconfiguration of the anomalous input gesture to the output gesture.

These associations, detections, reconfigurations, identifications, and resolutions are only described as example associations, detections, reconfigurations, identifications, and resolutions that can be generated with the application 302. Without departing the scope of the illustrative embodiments, many different types of gestures, anomalies, threshold metrics, conditions, and events can be similarly associated, detected, reconfigured, identified, and resolved in conjunction with other embodiments.

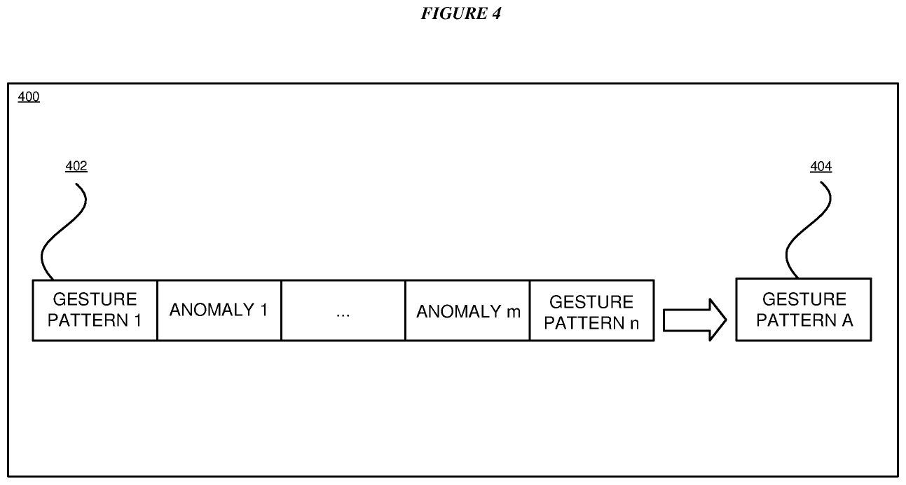

With reference to FIG. 4, this figure depicts a block diagram of an example manner of accepting a second input gesture instead of the first input gesture in accordance with an illustrated embodiment.

Gesture 402 comprises any number and type of gesture patterns. Gesture 402 is an anomalous input gesture. An application implementing an embodiment replaces anomalous gesture 402 with output gesture 404. Gesture 402 includes anomaly 403. An application implementing an embodiment fixes the anomalous gesture by removing or updating the anomalous gesture data with acceptable gesture data labeled “gesture pattern A”. Output gesture 404 does not include anomaly 403. The gesture patterns in gesture 402 may be unique gesture pattern instances, repetitive gesture patterns, singular or discrete gestures, continuous gestures, prolonged gestures occurring over a period, or some combination thereof.

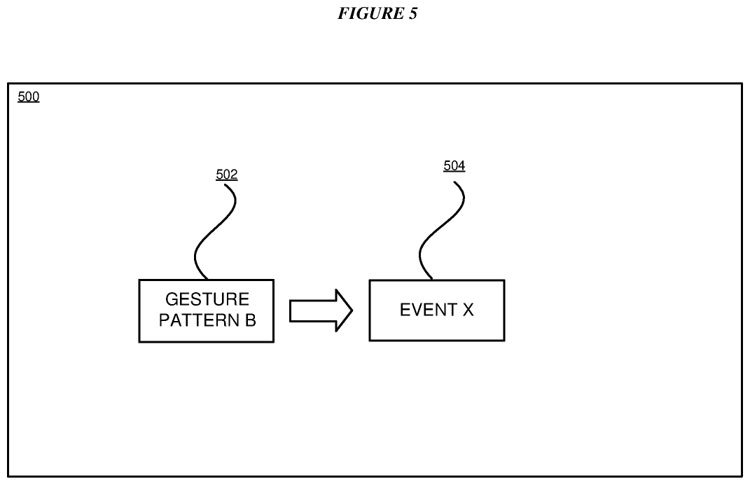

With reference to FIG. 5, this figure depicts a block diagram of an example manner of resolving an output gesture to a unique event in accordance with an illustrated embodiment. Gesture 502 is an example of output gesture 404 in FIG. 4.

An application implementing an embodiment resolves gesture 502 to a unique event, such as event 504. The application associates gesture 502 with event 504 labelled “event x”. An embodiment allows the application to detect any number and types of gestures and resolve them with any number and types of events, in any number and types of use-cases without limitations. A gesture can be singularly resolved with an event, multiple gestures can be resolved with the same event, or multiple events can be resolved with the same gesture, multiple gestures can be resolved with multiple events, or any suitable mix thereof. An embodiment can use suitable collaborating information, such as detected anomalies and identified conditions, to identify an applicable resolution, where plurality of resolutions between gesture pattern combinations and events are described.

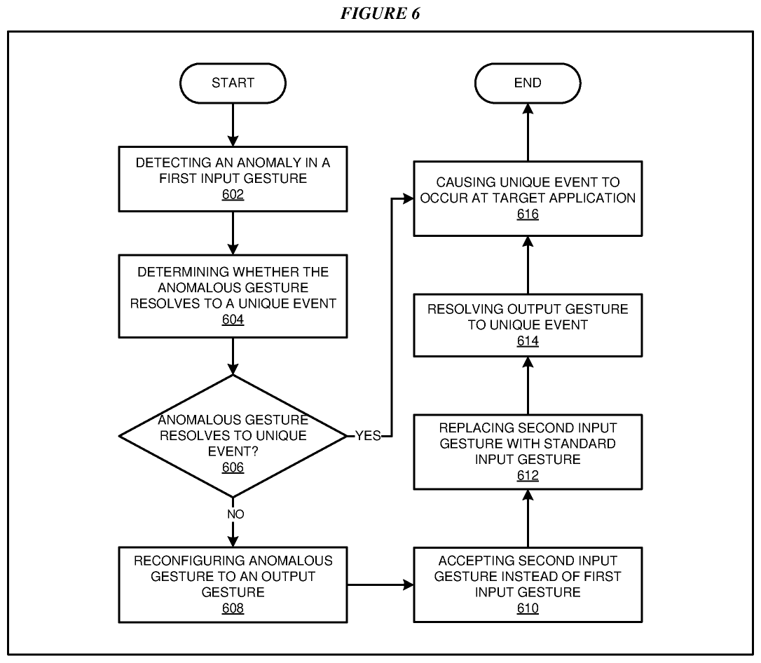

With reference to FIG. 6, this figure depicts a flowchart of an example process for dynamic device interaction reconfiguration in accordance with an illustrative embodiment. Process 600 can be implemented in application 134 or application 140 in FIG. 1.

The application, using a mobile device, detects an anomaly in a first input gesture (block 602). For example, an anomaly can be a failure to meet a threshold metric. Meeting a threshold metric can, but need not be an exact match, and can be a match within a tolerance value. The application determines whether the anomalous gesture resolves to a unique event (block 604).

If the anomalous gesture resolves to a unique event (“Yes” path of block 606), the application performs the event or operation associated with the anomalous gesture (block 608) and returns to block 602 to detect another anomalous gesture. If the anomalous gesture fails to resolve to a unique event (“No” path of block 606), the application reconfigures the anomalous gesture to an output gesture (block 610).

The application accepts a second input gesture instead of the first input gesture (block 612). The application replaces the second input gesture with a standard input gesture as output to a target application (block 614). The application resolves the output gesture to the unique event (block 616). The application causes, responsive to the output gesture, the unique event to occur at the target application. The application ends process 600 thereafter, or returns to block 602 to detect another gesture.

Thus, a computer implemented method, system or apparatus, and computer program product are provided in the illustrative embodiments for dynamic device interaction reconfiguration. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
detecting an anomaly in a first input gesture;
determining whether the anomalous gesture resolves to a unique event;
reconfiguring, responsive to the anomalous gesture failing to resolve to the unique event, the anomalous gesture to an output gesture by (i) accepting a second input gesture instead of the first input gesture, and (ii) replacing the second input gesture with a standard first gesture as output to a target application;
resolving the output gesture to the unique event; and
causing, responsive to the output gesture, the unique event to occur at the target application.

2. The method of claim 1, further comprising:
identifying, responsive to the anomalous gesture failing to resolve to the unique event, a condition in a performance of the first input gesture.

3. The method of claim 2, wherein the condition corresponds to a physical condition of a user.

4. The method of claim 2, wherein the identifying is performed at an application executing using a processor and a memory in a wearable device.

5. The method of claim 1, wherein the anomaly corresponds to the first input gesture failing to meet a threshold metric.

6. The method of claim 5, wherein a threshold metric is a threshold gesture data.

7. The method of claim 1, accepting the second input gesture instead of the first input gesture further comprising:
replacing gesture data corresponding to the anomalous gesture with gesture data corresponding to the second input gesture.

8. The method of claim 1, accepting the second input gesture instead of the first input gesture further comprising:
removing the anomaly from gesture data corresponding to the first input gesture.

9. The method of claim 1, further comprising:
notifying the target application of the replacement.

10. The method of claim 1, wherein the detecting is performed at an application executing using a processor and a memory in a wearable device.

11. The method of claim 1, further comprising:
overwriting an association of the stored gesture with the first event.

12. The method of claim 1, wherein the first input gesture comprises a series of motions.

13. A computer usable program product comprising a computer-readable storage device, and program instructions stored on the storage device, the stored program instructions comprising:
program instructions to detect an anomaly in a first input gesture;
program instructions to determine whether the anomalous gesture resolves to a unique event;
program instructions to reconfigure, responsive to the anomalous gesture failing to resolve to the unique event, the anomalous gesture to an output gesture by (i) accepting a second input gesture instead of the first input gesture, and (ii) replacing the second input gesture with a standard first gesture as output to a target application;
program instructions to resolve the output gesture to the unique event; and
program instructions to cause, responsive to the output gesture, the unique event to occur at the target application.

14. The computer usable program product of claim 13, wherein the computer usable code is stored in a computer readable storage device in a data processing system, and wherein the computer usable code is transferred over a network from a remote data processing system.

15. The computer usable program product of claim 13, wherein the computer usable code is stored in a computer readable storage device in a server data processing system, and wherein the computer usable code is downloaded over a network to a remote data processing system for use in a computer readable storage device associated with the remote data processing system.

16. The computer usable program product of claim 13, the stored program instructions further comprising:
identifying, responsive to the anomalous gesture failing to resolve to the unique event, a condition in a performance of the first input gesture

17. The computer usable program product of claim 16, wherein the condition corresponds to a physical condition of a user.

18. The computer usable program product of claim 16, wherein the identifying is performed at an application executing using a processor and a memory in a wearable device.

19. The computer usable program product of claim 13, wherein the anomaly corresponds to the first input gesture failing to meet a threshold metric

20. A computer system comprising a processor, a computer-readable memory, and a computer-readable storage device, and program instructions stored on the storage device for execution by the processor via the memory, the stored program instructions comprising:
program instructions to detect an anomaly in a first input gesture;
program instructions to determine whether the anomalous gesture resolves to a unique event;
program instructions to reconfigure, responsive to the anomalous gesture failing to resolve to the unique event, the anomalous gesture to an output gesture by (i) accepting a second input gesture instead of the first input gesture, and (ii) replacing the second input gesture with a standard first gesture as output to a target application;
program instructions to resolve the output gesture to the unique event; and
program instructions to cause, responsive to the output gesture, the unique event to occur at the target application.
